(19) United States
(12) Patent Application Publication
(10) Pub. No.: US 2021/0255773 A1
(43) Pub. Date: Aug. 19, 2021

(54) DISPLAY DEVICE FOR ENSURING STORAGE CAPACITY OF MEMORY

(71) Applicant: SAMSUNG ELECTRONICS CO., LTD., Suwon-si, Gyeonggi-do (KR)

(72) Inventors: Jinman KWON, Suwon-si, Gyeonggi-do (KR); Changhyeon CHAE, Suwon-si, Gyeonggi-do (KR)

(21) Appl. No.: 17/274,649

(22) PCT Filed: Sep. 11, 2019
(86) PCT No.: PCT/KR2019/011809

§ 371 Date: Mar. 9, 2021

(30) Foreign Application Priority Data
Oct. 12, 2018 (KR) 10-2018-0121528

(51) Int. Cl. G06F 3/06

(52) U.S. Cl. CPC G06F 3/0605; G06F 3/0631; G06F 2206/1008; G06F 3/0673; G06F 3/0653

(57) ABSTRACT

According to an embodiment of the disclosure, a display device may include a memory to store an application belonging to a first group executed without a trigger after execution-terminated, and an application belonging to a second group re-executed by a trigger after execution-terminated and a processor to measure a spare storage capacity indicating an amount of a spare space to store data by the memory, in which the processor may first terminate the application belonging to the second group rather than the application belonging to the first group, when selecting an application, which is to be terminated, of the application belonging to the first group and the application belonging to the second group, and when the spare storage capacity is equal to or less than a preset value. Besides, various embodiments understood based on the disclosure are possible.

### TECHNICAL FIELD

Embodiments of the disclosure relate to a technology for securing a storage capacity of a memory.

### BACKGROUND ART

As an information technology (IT) has been developed, service ranges to be provided to a user have been extensively increased in a display device. For example, the display device may provide, to a user, a movie, a drama, and an advertisement received over the Internet. In addition, to provide, to a user, a feeling similar to a reality space, the display device may output a 3D image, and the user may enjoy a game through the display device.

As various types of services may be provided to the user, and the size of the display device is increased, the number of applications executed at one time by the display device is increased. For example, an application to output a moving picture or an application to receive data from an external device may be simultaneously executed.

### DISCLOSURE

### Technical Problem

When several applications are simultaneously executed, the display device may terminate an unnecessary application to secure the storage capacity of the memory. However, some applications may be instantly re-executed as soon as the display device terminates the some applications. When the some applications are re-executed, the display device has to terminate the some applications again. Accordingly, data processing or calculation of the display device may be overloaded. In addition when some applications are executed, the storage capacity of the memory is not secured. Accordingly, a screen may be stopped.

Embodiments disclosed in the disclosure are to provide an electronic device to solve the above problems and to resolve the issues raised herein.

### Technical Solution

According to an embodiment of the disclosure, a display device may include a memory to store an application belonging to a first group executed without a trigger after execution-terminated, and an application belonging to a second group re-executed by a trigger after execution-terminated and a processor to measure a spare storage capacity indicating an amount of a spare space to store data by the memory, in which the processor may first terminate the application belonging to the second group rather than the application belonging to the first group, when selecting an application, which is to be terminated, of the application belonging to the first group and the application belonging to the second group, and when the spare storage capacity is equal to or less than a preset value.

According to an embodiment of the disclosure, a method of a display device may include measuring a spare storage capacity indicating an amount of a spare space to store data by a memory of the display device, determining whether an application, which is being executed in the display device, is an application belonging to a first group or an application belonging to a second group, when the spare storage capacity is equal to or less than a preset value, not terminating the application, which is being executed, when the application, which is being executed, is the application belonging to the first group, as a determination result, and terminating the application being executed, when the application, which is being executed, is the application belonging to the second group, as the determination result, and the application belonging to the first group may refer to an application which is re-executed without a trigger after execution-terminated, and the application belonging to the second group may refer to an application which is re-executed by a trigger after execution-terminated.

According to an embodiment of the disclosure, the display device may include a memory to store applications, an executing unit to classify the applications into a first group application re-executed without a trigger after execution-terminated, and a second group application re-executed by a trigger after execution-terminated, a measuring unit to measure a storage capacity indicating an amount of data to be stored in the memory, and a managing unit to determine whether an application, which is being executed, is included in the first group application or the second group application, when the storage capacity is equal to or less than a preset value, not to terminate the application being executed when the application belongs to the first group application as the determination result, and to terminate the application being executed when the application belongs to the second group application as the determination result.

### Advantageous Effects

According to embodiments disclosed herein, the storage capacity of the memory may be secured. According to embodiments of the disclosure, the driving performance of the processor may be improved.

Besides, a variety of effects directly or indirectly understood through the disclosure may be provided.

### DESCRIPTION OF DRAWINGS

FIG. 1 illustrates a display device according to a comparative example, and a display device according to an embodiment of the disclosure;

FIG. 2 is a block diagram of a display device, according to an embodiment;

FIG. 3 is a detailed block diagram of a display device, according to an embodiment;

FIG. 4 is a flowchart of a display device, according to an embodiment;

FIG. 5 is a detailed flowchart of a display device, according to an embodiment; and

FIG. 6 is a block diagram of a display device, according to an embodiment.

### MODE FOR INVENTION

Hereinafter, various embodiments of the disclosure may be described with reference to accompanying drawings. Accordingly, those of ordinary skill in the art will recognize that modification, equivalent, and/or alternative on the various embodiments described herein can be variously made without departing from the scope and spirit of the disclosure. With regard to description of drawings, similar components may be marked by similar reference numerals.

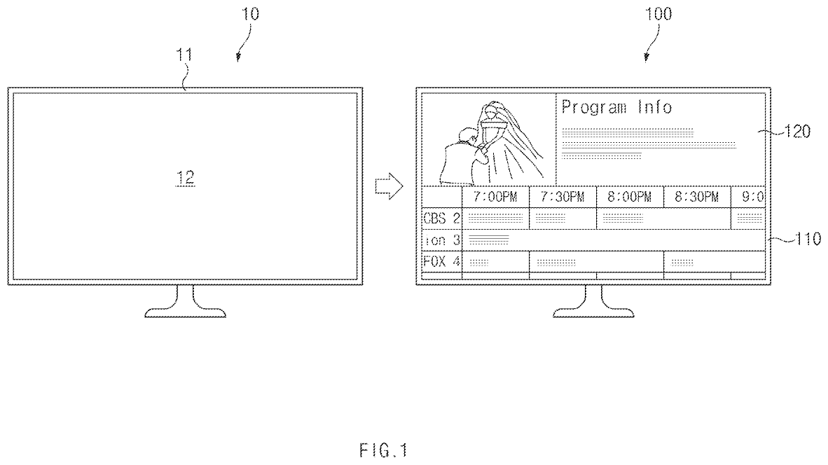

FIG. 1 illustrates a display device according to a comparative example, and a display device according to an embodiment of the disclosure.

Referring to 1, according to a comparative example, a display device 10 may include a housing 11 and a display 12.

The housing 11 may form an outer portion of the display device 10. The display 12 may be exposed through a cover glass included in the housing 11, and may output various types of content (e.g., a drama or a movie).

According to a comparative example, the display device 10 may terminate unnecessary some of applications being executed, when a storage capacity of a memory is insufficient. When the some applications are terminated, the storage capacity of the memory may be secured. Accordingly, the display device 10 may execute another application and may improve the driving performance of the display device 10.

However, some applications may be applications (hereinafter, a first group application or an application belonging to a first group) re-executed without a trigger, even if the execution of the some application is terminated. Even if the first group application is terminated, the first group application is immediately executed. Accordingly, the display device 10 has to terminate the first group application again. When the same operation is repeated as described above, the storage capacity of the memory may not be secured, and thus the driving performance of the display device 10 may be degraded. For example, as illustrated in FIG. 1, a blue screen may be output through the display 12 or a screen of the display 12 may be temporarily stopped.

According to an embodiment of the disclosure, a display device 100 may include a housing 110 and a display 120.

The housing 110 forms an outer portion of the display device 100, thereby protecting various components, which are included in the display device 100, from an external shock.

The display 120 may be provided inside the housing 110. The display 120 may output various types of content (e.g., a drama, or a movie), and may output different types of content depending on user inputs.

According to an embodiment of the disclosure, the display device 100 may store the first group application and a second group application (or an application belonging to a second group) executed by a trigger after execution-terminated. For example, a web-server demon may be included in the first group application. The web-server demon may execute an application corresponding to a request of a client or may provide a service corresponding to the request, when receiving the request of the client in a background state. The web-server demon immediately performs a specific operation in response to the request of the client. Accordingly, the web-server demon may be immediately re-executed even if the display device 100 terminates the execution of the web-server demon. According to another embodiment, a media application (YouTube™) may be included in the second group application. The media application may not exert an influence on another function of the display device 100, even if the media application is terminated. Accordingly, even if the display device 100 terminates the media application, the media application may not be re-executed as long as a specific trigger (e.g., a user input) is not applied.

According to an embodiment of the disclosure, the display device 100 may terminate the second group application without terminating the first group application, when the storage capacity of the memory is insufficient. When the second group application is terminated, the second group application is not re-executed without a specific trigger. Accordingly, the storage capacity of the memory may be secured, and the driving performance of the display device 100 may be improved. For example, as illustrated in FIG. 1, a phenomenon of outputting the blue screen or temporarily stopping the screen of the display 120 may not occur.

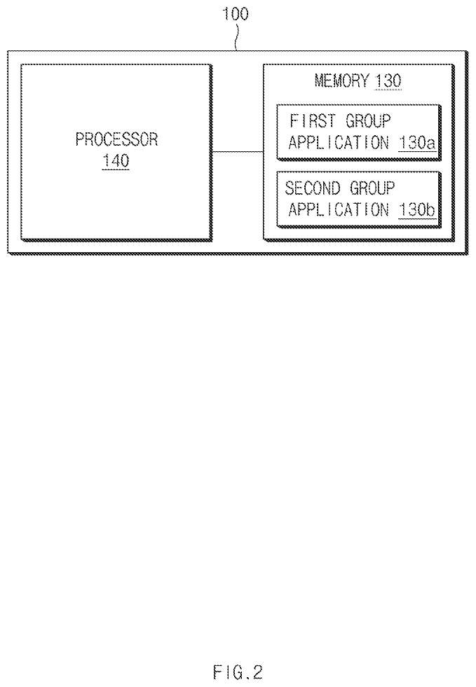

FIG. 2 is a block diagram of a display device, according to an embodiment. FIG. 2 illustrates a block diagram of components included in the display device 100 illustrated in FIG. 1.

Referring to FIG. 2, the display device 100 may include a memory 130 and a processor 140.

The memory 130 may store various data necessary to drive the display device 100. The data may include a first group application 130a, a second group application 130b, a program, or a relevant command. The program may include, for example, an operating system (OS), or a middleware. In the disclosure, the memory 130 may be referred to as a random access memory (RAM).

The processor 140 may be electrically connected with the memory 130. The processor 140 may execute a program to control another component (e.g., the display 120) connected with the processor 140 and may process and compute various data. For example, the processor 140 may change a screen which is output through the display 120 or may control an On/Off state of the display 120. In the disclosure, the processor 140 may be referred to as a central processing unit (CPU).

According to an embodiment, the processor 140 may measure a storage capacity (or a spare storage capacity) of the memory 130. The storage capacity may indicate an amount of a spare space in which the memory 130 stores data. The processor 140 may terminate the second group application 130b without terminating the first group application 130a, when the measured storage capacity is equal to or less than a preset value. In other words, the processor 140 may secure the storage capacity of the memory 130 by terminating the second group application 130b, when the storage capacity of the memory 130 is insufficient. When the storage capacity of the memory 130 is secured, the data processing ability or the calculation performance of the processor 140 may be improved, and a phenomenon of outputting the blue screen or temporarily stopping the screen of the display 120 may not occur.

According to an embodiment, the memory 130 may store the sequence of terminating the second group application 130b. The processor 140 may terminate the second group application 130b following the termination sequence without terminating the first group application 130a, when the storage capacity of the memory 130 is equal to or less than the preset value. For example, when an application ‘a’, an application ‘b’, and an application ‘c’ are stored in the memory 130 such that the applications are terminated in order of the application ‘a’, the application ‘b’, and the application ‘c’, the processor 140 may measure the storage capacity of the memory 130 and may terminate the applications in the above order.

According to an embodiment, the processor 140 may not terminate the first group application 130a and the second group application 130b, when the storage capacity of the memory 130 exceeds the preset value. In other words, when the storage capacity of the memory 130 is sufficient, because it is unnecessary to terminate an application which is being executed, the processor 140 may not terminate the first group application 130a and the second group application 130b.

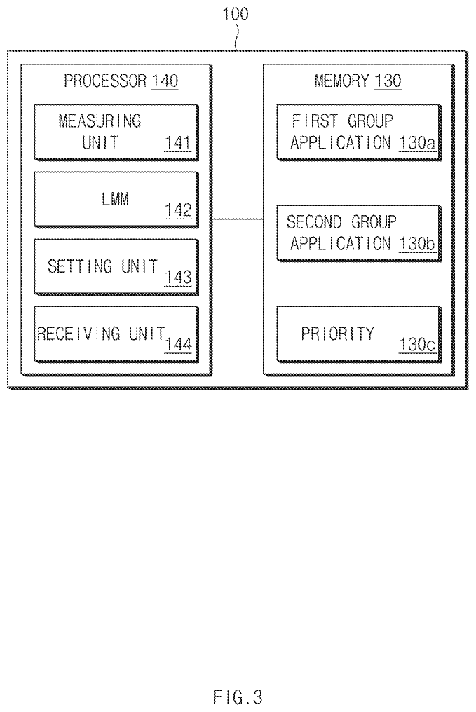

FIG. 3 is a detailed block diagram of a display device, according to an embodiment. FIG. 3 illustrates the detailed block diagram of FIG. 2.

Referring to FIG. 3, the memory 130 may include the first group application 130a, the second group application 130b, and a priority 130c. The priority 130c may refer to a reference value for terminating an application, which is being executed, when the storage capacity of the memory 130 is equal to or less than the preset value. For example, the priority 130c of the second group application 130b may be higher than the priority 130c of the first group application 130a. When the storage capacity of the memory 130 is equal to or less than the preset value, the processor 140 may terminate the second group application 130b having a higher priority 130c, or vice versa.

The processor 140 may include a measuring unit 141, a low memory management (LMM) 142, a setting unit 143, and a receiving unit 144.

The measuring unit 141 may measure the storage capacity of the memory 130. When the measured storage capacity exceeds the preset value, the measuring unit 141 may continuously perform a measuring operation until the storage capacity is equal to or less than the preset value. To the contrary, when the measured storage capacity is equal to or less than the preset value, the measuring unit 141 may notify the LMM 142 of that the storage capacity of the memory 130 is insufficient.

The LMM 142 may terminate the second group application 130b without terminating the first group application 130a, when the measured storage capacity is equal to or less than the preset value. According to an embodiment, the priorities 130c of the applications included in the second group application 130b may be different each other. The LMM 142 may sequentially terminate the applications included in the second group application 130b, based on the priorities 130c. In the disclosure, the LMM 142 may be referred to as a memory managing unit.

The setting unit 143 may set the priority 130c. For example, the setting unit 143 may set a higher priority 130c to the second group application 130b and may set a lower priority 130c to the first group application 130a. When the storage capacity of the memory 130 is equal to or less than the preset value, the LMM 142 may terminate the second group application 130b having the higher priority 130c, or vice versa.

According to an embodiment, the setting unit 143 may be included in the LMM 142. In other words, the LMM 142 may set the priorities 130c of the first group application 130a and the second group application 130b. When the storage capacity of the memory 130 is equal to or less than the preset value, the LMM 142 may terminate the second group application 130b having the higher priority 130c.

The receiving unit 144 may receive a user input. For example, when a user intends to execute the media application through a remote controller after the LMM 142 terminates the media application, the receiving unit 144 may receive the user input. The LMM 142 may execute the media application based on the user input, and may output a media execution screen through the display 120.

In the specification, components having the same reference numerals as those of the display device 100 illustrated in FIGS. 1 to 3 may have the same description as that made with reference to FIGS. 1 to 3. In addition, embodiments of the disclosure are provided for the illustrative purpose, and the display device 100 may include a component different from components illustrated in FIGS. 1 to 3, or may not include some of components illustrated in FIGS. 1 to 3.

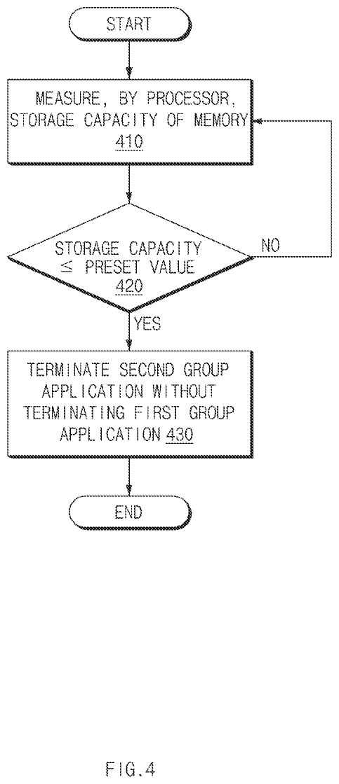

FIG. 4 is a flowchart of a display device, according to an embodiment. FIG. 4 is a view illustrating the operation of the display device 100 illustrated in FIG. 1.

Referring to FIG. 4, in operation 410, the processor 140 may measure the storage capacity of the memory 130. The storage capacity may refer to an amount of data that may be stored in the memory 130. For example, when the total storage capacity of the memory 130 is 4 GB, and an amount of the stored data is 3 GB, the storage capacity may be 1 GB.

In operation 420, the processor 140 may determine whether the storage capacity measured in operation 410 is equal to or less than a preset value. When the measured storage capacity exceeds the preset value, the processor 140 may repeatedly perform operation 410. To the contrary, when the measured storage capacity is equal to or less than the preset value, the processor 140 may perform operation 430. For example, when the preset value is 0.5 GB, and the storage capacity is 0.3 GB, the processor 140 may perform operation 430.

In operation 430, the processor 140 may terminate the second group application 130b without terminating the first group application 130a. In other words, the processor 140 may terminate the second group application 130b without terminating the first group application 130a, when the storage capacity of the memory 130 is insufficient. When the second group application 130b is terminated, the second group application is not re-executed without a specific trigger. Accordingly, the storage capacity of the memory 130 may be ensured, and data processing or computing performance of the processor 140 may be improved. Accordingly, a phenomenon of outputting the blue screen or temporarily stopping the screen of the display 120 may not occur.

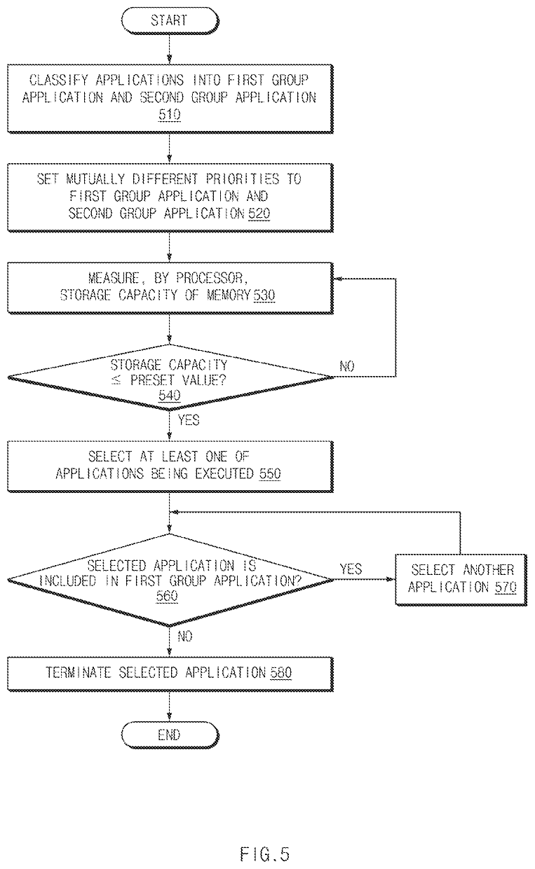

FIG. 5 is a detailed flowchart of a display device, according to an embodiment. FIG. 5 illustrates the detailed flowchart of FIG. 4.

Referring to FIG. 5, in operation 510, the processor 140 may classify applications, which are stored in the memory 130, into the first group application 130a and the second group application 130b. For example, the processor 140 may classify an application, which exerts an influence on the driving performance of the display device 100 when the execution of the application is terminated or should immediately perform a specific operation in response to the request of a client, as the first group application 130a. In other words, the processor 140 may classify an application, which is re-executed without a specific trigger even if the execution of the application is terminated, as the first group application 130a. To the contrary, the processor 140 may classify an application, which does not exert an influence on the driving performance of the display device 100 even if the execution of the application is terminated, as the second group application 130b. In other words, the processor 140 may classify the application, which is not re-executed without the specific trigger when the execution of the application is terminated, as the second group application 130b.

In operation 520, the processor 140 may set mutually different priorities 130c to the first group application 130a and the second group application 130b. The processor 140 may set a lower priority 130c to the first group application 130b and may set a higher priority 130c to the second group application 130a, or vice versa.

In operation 530, the processor 140 may measure the storage capacity of the memory 130. For example, when the total storage capacity of the memory 130 is 4 GB, and an amount of the stored data is 3 GB, the storage capacity may be 1 GB.

In operation 540, the processor 140 may determine whether the storage capacity measured in operation 530 is equal to or less than the preset value. When the measured storage capacity exceeds the preset value, the processor 140 may repeatedly perform operation 530. To the contrary, when the measured storage capacity is equal to or less than the preset value, the processor 140 may perform operation 550.

In operation 550, the processor 140 may select at least one of applications being executed. For example, in the state that the application ‘a’, the application ‘b’, and the application ‘c’ are being executed, the processor 140 may select the application ‘a’.

In operation 560, the processor 140 may determine whether the application selected in operation 550 is included in the first group application 130a. When the application selected in operation 550 is included in the first group application 130a, operation 570 may be performed. When the application selected in operation 550 is not included in the first group application 130a, operation 580 may be performed. When the application selected in operation 550 is included in the first group application 130a, the processor 140 may select another application without terminating the application selected in operation 550. To the contrary, when the application selected in operation 550 is not included in the first group application 130a (is included in the second group application 130b), the processor 140 may terminate the application selected in operation 550.

According to an embodiment, in operation 560, the processor 140 may measure the priority 130c of the application selected in operation 550. The processor 140 may determine whether the application selected in operation 550 is included in the first group application 130a, based on the priority 130c.

In operation 570, the processor 140 may select another application instead of the application selected in operation 550. According to an embodiment, the processor 140 may select the application ‘b’ among the application ‘a’, the application ‘b’, and the application ‘c’. When the application ‘b’ is included in the first group application 130a, the processor 140 may repeatedly perform operation 570. When the application ‘b’ is not included in the first group application 130a, the processor 140 may terminate the application ‘b’.

In operation 580, the processor 140 may terminate the application selected in operation 550. In other words, when the application selected in operation 550 is included in the second group application 130b, the processor 140 may terminate the execution of the selected application.

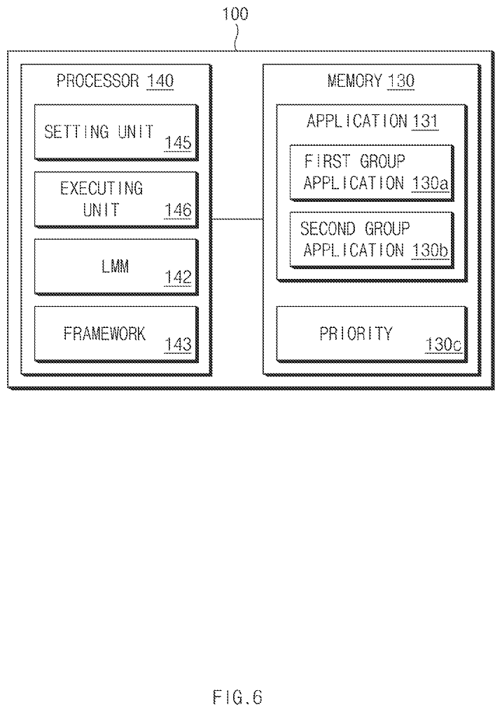

FIG. 6 is a block diagram of a display device, according to another embodiment. FIG. 6 is a view that the display device 100 classifies the first group application 130a and the second group application 130b. For example, FIG. 6 is a view illustrating operations 510 and 520 of FIG. 5 in detail.

Referring to FIG. 6, the processor 140 may include an executing unit 145 and a framework 146.

The executing unit 145 may be a module to execute an application stored in the memory 130. When an application 131 is executed, the executing unit 145 may classify the application 131 as the first group application 130a or the second group application 130b. For example, the executing unit 145 may classify the application 131 as the first group application 130a or the second group application 130b by making reference to a file including whether to re-execute the application 131, when executing the application 131. The file may include a text file, a service file, or a proc system file, and may be stored in the memory 130.

According to an embodiment, the executing unit 145 may set mutually different priorities 130c to the first group application 130a and the second group application 130b. The executing unit 145 may set a lower priority 130c to the first group application 130a and may set a higher priority 130c to the second group application 130b, or vice versa.

The framework 146 may be a module to execute an application stored in the memory 130. When the application 131 is executed, the framework 146 may classify the application 131 as the first group application 130a or the second group application 130b. When the application 131 is classified, the framework 146 may transmit the classification result to the setting unit 143. According to an embodiment, the setting unit 143 having the classification result received therein may set mutually different priorities 130c to the first group application 130a and the second group application 130b. For example, the setting unit 143 may set a lower priority 130c to the first group application 130b and may set a higher priority 130c to the second group application 130b, or vice versa.

The LMM 142 may measure the storage capacity of the memory 130. The LMM 142 may measure the priority 130c of the application being executed, when the measured storage capacity is equal to or less than the preset value. The LMM 142 may determine whether the application selected is included in the first group application 130a, based on the priority 130c. When the application being executed is included in the first group application 130a, the LMM 142 may not terminate the application being executed. When the application being executed is included in the second group application 130b, the LMM 142 may terminate the application being executed.

According to an embodiment of the disclosure, a display device may include a memory to store an application belonging to a first group executed without a trigger after execution-terminated, and an application belonging to a second group re-executed by a trigger after execution-terminated and a processor to measure a spare storage capacity indicating an amount of a spare space to store data by the memory, in which the processor may first terminate the application belonging to the second group rather than the application belonging to the first group, when the spare storage capacity is equal to or less than a preset value.

According to an embodiment of the disclosure, the memory may store data indicating whether to re-execute the application belonging to the first group and the application belonging to the second group, and the processor may classify, based on the data, applications, which are stored in the memory, into the application belonging to the first group and the application belonging to the second group.

According to an embodiment of the disclosure, the processor may set mutually different priorities to the application belonging to the first group and the application belonging to the second group, and the priority may refer to a reference value for terminating an application, which is being executed, when the spare storage capacity is equal to or less than the preset value.

According to an embodiment of the disclosure, the data may include at least one of a text file, a service file, or a proc system file.

According to an embodiment of the disclosure, the processor may not terminate the application belonging to the first group and the application belonging to the second group, when the spare storage capacity of the memory exceeds the preset value.

According to an embodiment of the disclosure, the display device may further include a receiving unit to receive a user input, and the processor may execute the application belonging to the second group, in response to the user input.

According to an embodiment of the disclosure, the memory may further store a sequence of terminating applications belonging to the second group, and the processor may terminate the applications belonging to the second group in the sequence, when the spare storage capacity is equal to or less than the preset value.

According to an embodiment of the disclosure, the memory may correspond to a random access memory (RAM), and the processor may correspond to a central processing unit (CPU).

According to an embodiment of the disclosure, the display device may further include a display to output an execution screen of at least one of the application belonging to the first group or the application belonging to the second group.

According to an embodiment of the disclosure, the display device may include a memory to store applications and a processor to classify the applications into an application belonging to a first group executed without a trigger after execution-terminated, and an application belonging to a second group re-executed by a trigger after execution-terminated. The processor may measure a storage capacity indicating an amount of data to be stored in the memory, may determine whether an application being executed is included in the first group application or the second group application, when the storage capacity is equal to or less than a preset value, may not terminate the application being executed when the application belongs to the first group application as the determination result, and may terminate the application being executed when the application belongs to the second group application as the determination result.

According to an embodiment of the disclosure, the processor may set mutually different priorities to the application belonging to the first group and the application belonging to the second group, and the priority may refer to a reference value for terminating an application, which is being executed, when the spare storage capacity is equal to or less than the preset value.

According to an embodiment of the disclosure, the processor may determine the application, which is being executed, as belonging to the second group application, when a priority of the application being executed is equal to or more than a preset level, and may determine the application, which is being executed, as belonging to the first group application, when the priority of the application being executed is less than the preset level.

According to an embodiment of the disclosure, the memory may store data indicating whether to re-execute the application belonging to the first group and the application belonging to the second group, and the processor may classify the applications stored in the memory into the first group application and the second group application, based on the data.

According to an embodiment of the disclosure, the data may include at least one of a text file, a service file, or a proc system file.

According to an embodiment of the disclosure, the display device may further include a display to output content of the application being executed.

According to an embodiment of the disclosure, the display device may include a memory to store applications, an executing unit to classify the applications into a first group application executed without a trigger after execution-terminated, and a second group application re-executed by a trigger after execution-terminated, a measuring unit to measure a storage capacity indicating an amount of data to be stored in the memory, and a managing unit to determine whether an application being executed is included in the first group application or the second group application, when the storage capacity is equal to or less than a preset value, not to terminate the application being executed when the application belongs to the first group application as the determination result, and to terminate the application being executed when the application belongs to the second group application as the determination result.

According to an embodiment of the disclosure, the memory may store data indicating whether to re-execute the first group application and the second group application, and the executing unit may classify, based on the data, applications, which are stored in the memory, into the first group application and the second group application.

According to an embodiment of the disclosure, the data may include at least one of a text file, a service file, or a proc system file.

According to an embodiment of the disclosure, the display device may further include a setting unit to set mutually different priorities to the first group application and the second group application, and the priority may refer to a reference value for terminating an application, which is being executed, when the storage capacity is equal to or less than the preset value.

According to an embodiment of the disclosure, the display device may further include a display to output content of the application being executed.

According to an embodiment of the disclosure, a method of a display device may include measuring a storage capacity indicating an amount of data to be stored in a memory of the display device, determining whether an application, which is being executed in the display device, is a first group application or a second group application, when the storage capacity is equal to or less than a preset value, not terminating the application, which is being executed, when the application being executed is the first group application, as a determination result, and terminating the application being executed, when the application being executed is the application belonging to the second group, as the determination result, and the first group application may refer to a group application in a group which is re-executed without a trigger after execution-terminated, and the second group application may refer to a group application which is re-executed by a trigger after execution-terminated.

According to an embodiment of the disclosure, the method may further include setting mutually different priorities to the first group application and the second group application, and the priority may refer to a reference value for terminating an application, which is being executed, when the storage capacity is equal to or less than the preset value.

According to an embodiment of the disclosure, the determining of whether the application, which is being executed in the display device, is the first group application or the second group application may include determining the application, which is being executed, as the second group application, when a priority of the application being executed is equal to or more than a preset level, and may determine the application, which is being executed, as the first group application, when the priority of the application being executed is less than the preset level.

According to an embodiment of the disclosure, the method may further include storing, in the memory, data indicating whether to re-execute the first group application and the second group application, and classifying, based on the data, applications, which are stored in the memory, into the first group application and the second group application.

According to an embodiment of the disclosure, the data may include at least one of a text file, a service file, or a proc system file.

According to an embodiment of the disclosure, the method may further include outputting content of the application being executed.

The display device according to various embodiments may be one of various types of devices. The display devices may include, for example, a TV, a portable communication device (e.g., a smartphone), a computer device, a portable multimedia device, a portable medical device, a camera, a wearable device, or a home appliance. According to an embodiment of the disclosure, the display devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “unit” (e.g., executing unit, setting unit, or receiving unit) or “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software including one or more instructions that are stored in a storage medium or an external memory that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. A display device comprising:
a memory configured to store an application belonging to a first group executed without a trigger after execution-terminated, and an application belonging to a second group re-executed by a trigger after execution-terminated; and
a processor configured to measure a spare storage capacity indicating an amount of a spare space to store data in the memory,
wherein the processor is configured to:
first terminate the application belonging to the second group rather than the application belonging to the first group, when selecting an application, which is to be terminated, of the application belonging to the first group and the application belonging to the second group, when the spare storage capacity is equal to or less than a preset value.

2. The display device of claim 1, wherein the memory stores data indicating whether to re-execute the application belonging to the first group and the application belonging to the second group, and
wherein the processor is configured to:
classify, based on the data, applications, which are stored in the memory, into the application belonging to the first group and the application belonging to the second group.

3. The display device of claim 2, wherein the processor is configured to:
set mutually different priorities to the application belonging to the first group and the application belonging to the second group, and
wherein the priority refers to a reference value for terminating an application, which is being executed, when the spare storage capacity is equal to or less than the preset value.

4. The display device of claim 2, wherein the data includes:
at least one of a text file, a service file, or a proc system file.

5. The display device of claim 1, wherein the processor is configured not to:
terminate the application belonging to the first group and the application belonging to the second group, when the spare storage capacity of the memory exceeds the preset value.

6. The display device of claim 1, further comprising:
a receiving unit to receive a user input,
wherein the processor is configured to:
execute the application belonging to the second group, in response to the user input.

7. The display device of claim 1, wherein the memory further stores a sequence of terminating applications belonging to the second group, and
wherein the processor is configured to:
terminate the applications belonging to the second group in the sequence, when the spare storage capacity is equal to or less than the preset value.

8. The display device of claim 1, wherein the memory corresponds to a random access memory (RAM), and the processor corresponds to a central processing unit (CPU).

9. The display device of claim 1, further comprising:
a display configured to output an execution screen of at least one of the application belonging to the first group or the application belonging to the second group.

10. A method of a display device, the method comprising:
measuring a spare storage capacity indicating an amount of a spare space to store data in a memory of the display device;
determining whether an application, which is being executed in the display device, is an application belonging to a first group or an application belonging to a second group, when the spare storage capacity is equal to or less than a preset value;
not terminating the application being executed, when the application being executed is the application belonging to the first group, as a determination result; and
terminating the application being executed, when the application being executed is the application belonging to the second group, as the determination result,
wherein the application belonging to the first group refers to an application re-executed without a trigger after execution-terminated, and the application belonging to the second group refers to an application re-executed by a trigger after execution-terminated.

11. The method of claim 10, further comprising:
setting mutually different priorities to the application belonging to the first group and the application belonging to the second group,
wherein the priority refers to a reference value for terminating the application, which is being executed, when the spare storage capacity is equal to or less than the preset value.

12. The method of claim 11, wherein the determining of whether the application being executed is the application belonging to the first group or the application belonging to the second group includes:
determining the application, which is being executed, as the application belonging to the second group, when a priority of the application being executed is equal to or greater than a preset level; and
determining the application, which is being executed, as the application belonging to the first group, when the priority of the application being executed is less than the preset level.

13. The method of claim 10, further comprising:
storing, in the memory, data indicating whether to re-execute the application belonging to the first group and the application belonging to the second group, and
classifying, based on the data, applications, which are stored in the memory, into the application belonging to the first group and the application belonging to the second group.

14. The method of claim 13, wherein the data includes:
at least one of a text file, a service file, or a proc system file.

15. The method of claim 10, further comprising:
outputting content of the application being executed.
